(19) United States
(12) Patent Application Publication
(10) Pub. No.: US 2008/0306772 A1
(43) Pub. Date: Dec. 11, 2008

(54) System and Method for Providing a Personal Internet of Objects and Information

(75) Inventor: Mohammad Shahrokh, Saratoga, CA (US)

Correspondence Address: FLIESLER MEYER LLP, 650 CALIFORNIA STREET, 14TH FLOOR, SAN FRANCISCO, CA, 94108, US

(73) Assignee: PERSONAL INFONET, INC., Vancouver, WA (US)

(21) Appl. No.: 12/119,370

(22) Filed: May 12, 2008

Related U.S. Application Data
(60) Provisional application No. 60/917,600, filed on May 11, 2007.

(51) Int. Cl. G06Q 10/00

(52) U.S. Cl. 705/3

(57) ABSTRACT

A system and method are described for managing a personal Internet of objects and information, and applying the information to enhance the quality of daily activities such as situations where personal medical information is required but otherwise not available. The device can be used for performing various functions, such as re-ordering medication, keeping track of valuable objects, locating missing objects, performing authenticated financial transactions, contacting service providers to report failures and scheduling appointments. An information gathering module collects and organizes data on objects in partially pre-configured templates on a Personal Internet Card (PIC) embedded in an electronic device. Templates determine how that data is applied in the real world, and keep track of usage. Data collection by the PIC can be through wireless means or hardwire communication. A PIC-enabled device could apply the information and specific knowledge of objects in a manner that enhances the daily activities of its owner.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to managing personal user information and more particularly to electronically managing an information paper trail via a personal internet card device.

### BACKGROUND

Often times, when disparate data is integrated and analyzed, useful information can be extracted to benefit people. Applying this information can benefit people by enabling them to move beyond historical limitations. Today, there are many opportunities for improving the quality of life by integrating disparate data and applying useful information. Each of us is at the center of our personal world and responsible for orchestrating activities that touch our lives. In doing so, we are required to collect data from one area of our world, convert it in to useful information, and then make it available to another area. Often we have to make the time and expend the energy to analyze the raw data and consider historical data in order to extract useful information from it. This orchestration becomes more of a challenge when we are busy and as we get older. The challenges could be due to memory deterioration, having less energy, fear, or our inability to control stress as well as we used to when we were younger. With the growing number of people joining this group and their desire to continue to engage the world for as long as possible, an increasing number of activities have become difficult to orchestrate.

Take the example of an elderly patient who needs to visit several physicians in order to receive diagnosis and obtain medication that could improve their situation. Often these people face long delays in receiving a diagnosis because their physicians do not have access to one another's diagnosis. At times they receive the wrong diagnosis because physicians are looking too closely at a tree to see the forest. Consequently, some patients expend enormous energy in an attempt to help the process by taking on the responsibility of collecting historical information. They visit one or more physicians and make many phone calls; energy that they do not have because of their medical condition or age. Lack of historical information may also result in redundant blood work, radiology work, and incompatible medication. Each of these redundant steps could have a ripple affect such as delays in receiving medication because of incompatibilities with other medication or the refusal of insurance to pay. While some people attempt to help themselves by accumulating a paper trail, X-ray, MRI and CT scans, and lab reports, others simply wait and suffer because in their minds they have relinquished the responsibility to their physicians. In certain situations such as a visit to the emergency room of a hospital the wait could be life threatening. Not all patients are confined to their homes, most attempt to live as much a normal life as possible. In addition to orchestrating all the events that they used to manage before their illness, these people may have to make sure that they take their medication, car keys, cellular telephones, credit cards, and other items with them wherever they go. Forgetting one of these items such as a medication could have secondary effects such as the increased stress of having forgotten the medication to being at risk for not taking it in a timely manner.

Today's processes have common impacts on our lives. They all consume more time than we would like to give. They cause stress. They require us to perform many activities grudgingly such as going back and-forth to the doctor's office or labs in order to obtain reports; or make phone calls to the pharmacy, our insurance provider, and a physician in order not to incur out of pocket medication expenses. We perform these activities because we are attempting to improve our condition, such as an illness, but at the back of our minds we wish that there were easier ways to get the job done. Many of these activities have associated costs such as the cost of fuel, photocopying documents, mailing them, or paying fees to obtain our records. Last-but-by-no-means-least, they cause missed opportunities such as spending time with family, going to work, resting, or going for workout.

Such challenges and their impacts on our lives increase with age and decline in our mental and physical capabilities, access to utilities such as an automobile, telephone, computers, the Internet, fax machine, funds, and assistance from more capable people. At any point in time, we could be orchestrating activities across different sectors of our lives such as home, work, travel, healthcare, entertainment, school, purchases, transportation, sports, hobbies, services, and government. The more sectors and the more activities within each sector, the more likely that we are going to suffer from stress, forget something and not be as effective as we would like to be. These sectors have common attributes such as people, objects, and raw data. Orchestration involves accumulation and organization of disparate raw data, application of one or more rules and procedures to the raw data in order to extract useful information and/or make a decision, and the dissemination of useful information to one or more sectors of our world. Reducing the number of manual activities, the amount of time spent performing them, and the associated costs, could help improve the quality of our lives.

Even the most informative of prior art are grossly inadequate in their attempt to achieve this objective. In some cases such as a plastic medical card or microfilm, they are based on incomplete and out-of-date information. In more advanced cases such as injecting an RFID tag under the skin, the solution operates within a specific facility and the focus is on identifying a person or an object. In some cases tracking objects requires utilization of large RF antennas, making its widespread use impractical. At best, they are cumbersome mechanisms for collecting data that was true at a certain point in time. They do not offer the means to continuously update the raw data, analyze it, extract useful information from it, apply situation-specific rules to enable decision-making, and take actions on our behalf

### SUMMARY

A system and method are provided for managing a personal internet of objects and information and applying that information to enhance the quality of daily activities, such as managing a paper trail of medical information. A Personal Internet Card (PIC) is described, which can store and organize various information, such as object identities, descriptions and situational data into a set of templates. The PIC can be a standalone device or, alternatively, can be embedded/inserted into a personal digital assistant (PDA), a cellular telephone, a personal internet portable module, a personal internet stationary module or any other smart electronic device such as a computer. Being embedded can enable the personal internet card to utilize the processing capability and/or memory storage capacity of the electronic host device.

An information gathering module can collect the information and organize it in a set of partially pre-configured templates on the electronic device. In one embodiment, the information gathering module is a software application deployed on the PIC and executed by a central processing unit (CPU). A set of templates can be stored in a memory storage medium of the personal internet card and each template can contain one or more fields specifically pre-configured for a particular application that is adapted to manipulate the data in the template, such as a medical information application that communicates and retrieves patient-specific data from a medical records system of a hospital.

Embodiments of the present invention provide systems and methods for the creation of a personal internet through accumulation and organization of disparate raw data from one or more sectors of our personal world, application of one or more rules on the raw data in order to extract useful information, and the dissemination of that information to one or more sectors of our world. As such, aspects of the present invention can perform the following functions and objectives:

Enable the user to create templates describing personal information such as name, biometric data, telephone number, credit card information, and emergency contacts.

Enable the user to create templates describing operational information such as Internet communication addresses and configuration data, levels of security, folders, and whether the unit is operating in the standalone mode or as a member of a network of Personal Internet devices.

Enable the user to define the role of a Personal Internet device when it becomes a member in a network of Personal Internet devices.

Enable the user to define operational procedures describing conditions and actions to be taken when a condition is met, such as sounding a notification alarm when it is time to take medication or if the owner leaves behind their medication.

Enable the user to define procedures describing a list of steps to be taken such as contact a list of doctors and collect the latest medical report, or contact the pharmacy and re-order a list of medication.

Enable the user to define a list of objects by declaring their name, identification, and description.

Enable the user to define object role such as: medication can be ordered, reminded, purchased, and should not be forgotten; but they cannot be captured or transmitted.

Enable the user to define the maximum distance allowed between an object and the user.

Enable the user to define the type of warning they would like to receive in case the distance between the user and a tracked object reaches the maximum limit.

Enable the user to purchase objects using personal information such as credit card data.

Enable the user to purchase objects using personal information such as biometric data.

Perform purchase transactions utilizing the Internet.

Perform purchase transactions utilizing NFC.

Enable the user to receive textual, graphical and image data such as copies of medical records and X-rays.

Enable the user to send textual, graphical and image data.

Warn the user that the distance between an object that they wish to track is at the maximum limit.

Communicate with other Personal Internet devices.

Establish role within a network of Personal Internet devices.

Exchange data with other Personal Internet devices

### BRIEF DESCRIPTION OF THE DRAWINGS

FIG. 1 illustrates the operational context of the Personal Internet of Objects and Information.

FIG. 2 illustrates the operational context of a PIC-enabled device.

FIG. 3 illustrates how the Personal Internet Portable Module setup is enabled by a personal computer.

FIG. 4 illustrates how the Personal Internet Portable Module biometric data acquisition setup is enabled by a personal computer.

FIG. 5 illustrates how basic setup is achieved at the Personal Internet Portable Module without involving a personal computer.

FIG. 6 illustrates how basic and biometric setup are achieved at the Personal Internet Portable Module without involving a personal computer.

FIG. 7 illustrates how basic setup is achieved at the Personal Internet Stationary Module without involving a personal computer.

FIG. 8 illustrates how basic and biometric setup are achieved at the Personal Internet Stationary Module without involving a personal computer.

FIG. 9 illustrates the software architecture.

FIG. 10 illustrates the logical hardware architecture.

FIG. 11 illustrates PIC Operation Structure.

FIG. 12 illustrates PIC Setup Structure.

FIG. 13 illustrates Object Management Structure.

FIG. 14 illustrates Healthcare Management Functions.

FIG. 15 illustrates the scenario for visiting a physician.

FIG. 16 illustrates the scenario for a remote (e.g. from home) dialogue between a PIC-enabled device and the physician system.

FIG. 17 illustrates the general logical processes in accordance with various embodiments.

FIG. 18 is an illustration of an exemplary set of templates for storing data onto the personal internet card, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in an accessible device or appliance with storage capacity. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided systems and methods for a personal internet of objects and information. A personal internet card (PIC) is described, which contains a central processing unit (CPU), a storage medium and a wireless communication component. The storage medium can contain information associated with the user of the card. In one embodiment, medical information is contained in a set of templates on the card, including patient-specific laboratory data, medication prescription data, physician notes, information about medical procedures, test results, X-ray, MRI and CT-Scan data as well as various other types of information associated with a medical user. The wireless communications component can enable the CPU of the PIC to connect to one or more networks and communicate with other electronic devices such as the medical records system of a hospital. The central processing unit (CPU) can execute various applications deployed on the PIC, such as the information gathering module. In one embodiment, a medical application on the PIC can contact the medical records system, identify the PIC as being associated with a particular user, retrieve medical information associated with that user and organize and store the medical information into one or more templates on said storage medium of the internet card.

In one embodiment, the templates are pre-configured with one or more fields for containing specific types of data tailored for a particular usage. Therefore each template-type is designed for a specific application, such as medical information or credit card purchase over the internet These templates can be stored on the PIC (which can be embedded in a mobile device) or on a computer hard disk. The templates enable organization of the descriptive data into static and functional categories. Static data can be composed of text and numeric values such as a person's name. Static data can be stored, retrieved, displayed, communicated, and validated. Functional data, on the other hand, can govern how the static data should be used as well as services that could be offered to the user. For example, certain data and functions may be restricted to a portable device while others could span portable and fixed devices.

In one embodiment, a setup module collects and organizes object identities and their respective descriptions in partially pre-populated templates. This module includes a human interface, data processing logic, and data storage/retrieval logic. It displays a list of available templates and enables the user to choose one that they wish to complete. When a template is selected all the fields within the template can be displayed. When the user enters object-specific data into each field of the template, the data content and context can be validated to make sure that it can be correctly applied according to the template's intended use. If the data cannot be correctly applied, a warning or an error message can be displayed to the user, giving them a chance to make the correction. When all data fields have been correctly entered, the user is enabled to save the completed template on a computer static memory or a PIC.

Entry errors can be communicated to the user through a text message, synthesized voice, audible tone, or visual notifications such as graphical icons.

The setup module could be enhanced by a biometric device capable of capturing specific biometric data from the owner. The biometric data will be validated for completeness and stored in a corresponding template.

When populated templates are created on a computer they can then be downloaded to a PIC. A PIC could be inserted into or pre-embedded in a Personal Internet Portable Module, a Personal Internet Stationary Module, a PDA, a cellular telephone, or an intelligent electronic device such as a computer.

When populated templates are created directly on a Personal Internet Portable Module or a Personal Internet Stationary Module, the data is either stored on the non-volatile memory of the PIC or on a non-volatile memory accessible by the PIC.

Information download to the PIC could be enabled through wireless (such as Wi-Fi or Bluetooth) or hardwired communication (such as USB, NFC or a LAN). These portable and fixed devices may be configured to communicate with one another establishing continuity in the owner's actions as he/she moves from one place to another. Inter-device communication is achieved through RF-type means such as Wi-Fi, NFC or cellular telephone.

Objects in the personal Internet can be tagged with an identity and optional descriptive data. Object identities and descriptive data can be communicated to the PIC through various forms of RF technologies such as RFID. A PIC-enabled device could then apply information embedded in a template and the specific knowledge of an object in a manner that would enhance the daily activities of its owner.

In various embodiments, the PIC functions as a health monitoring device that monitors and reports on a user's health status. As an illustration, the personal internet card can establish a connection to an electronic health monitoring device such as a blood sugar monitor of a diabetes patient. The connection can be a wireless connection or a wired connection. Upon establishing communication with the device, the PIC can read the health information from the device and write the data into the storage medium. In one embodiment, the health status information from the device can be periodically transmitted to an external system such as a physician's computer, thereby reporting the health status of a patient (e.g. twice per day). As an example, the PIC can establish an internet/network connection upon reading the data from the health monitoring device, generate an electronic mail (email) message and transmit the email message to an appropriate email address at the medical facility. It should be noted that the health monitoring device can take the form of any electronic device that can obtain health information about a person, including but not limited to blood pressure monitors, blood sugar monitors, vital signs monitors, heart rate monitors, pulse monitors, electrocardiogram monitors, respiration monitors and a temperature monitors. It should also be noted that the PIC can transmit the information obtained from the device immediately, or can alternatively store the health data for later use, such as during the connection to a medical records system, as described above.

In one embodiment, the PIC can also provide the functionality of a universal serial bus (USB) memory storage device. For example, a physical connection can be established between a personal computer and the PIC via the USB interface and files and data can be manually transferred by a user for storage onto the storage medium of the PIC. In this manner, various users can manually store and retrieve data for personal use in addition to the automated maintenance of medical information stored in the templates, as previously described.

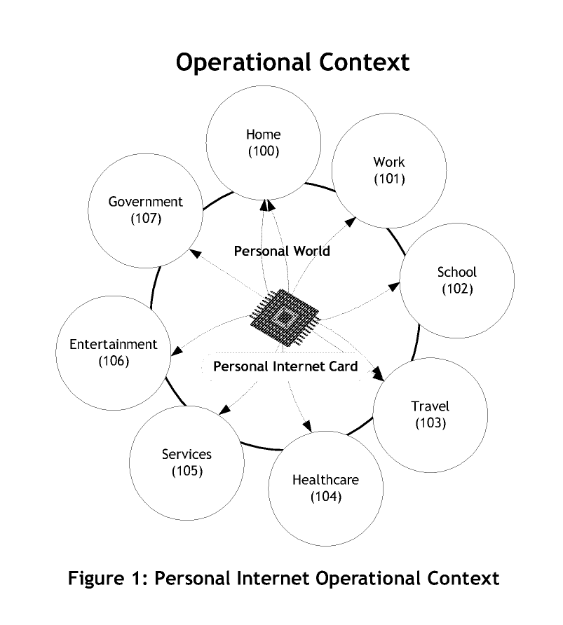

FIG. 1 is an exemplary illustration of the operation context of the personal internet, in accordance with various embodiments. Although this diagram, as well as other diagrams discussed throughout this disclosure, depicts components as logically separate, such depiction is merely for illustrative purposes. It will be apparent to those skilled in the art that the components portrayed in this or other figures can be arbitrarily combined or divided into separate software, firmware and hardware, or can be distributed among different computing devices, or connected by one or more networks or other suitable communication means.

Referring to FIG. 1, each embodiment of the present invention provides systems and methods for the creation of a personal internet through accumulation and organization of disparate raw data from one or more sectors of our personal world, application of one or more rules on the raw data in order to extract useful information, and the dissemination of that information to one or more sectors of our world. As shown, the home 100, work 101, school 102, government 107, entertainment 106, travel 103, healthcare 104 and other services 105 comprise an exemplary list of such sectors. In one embodiment, the PIC can help an everyday user with maintaining and automating the information paper trail associated with any of these sectors.

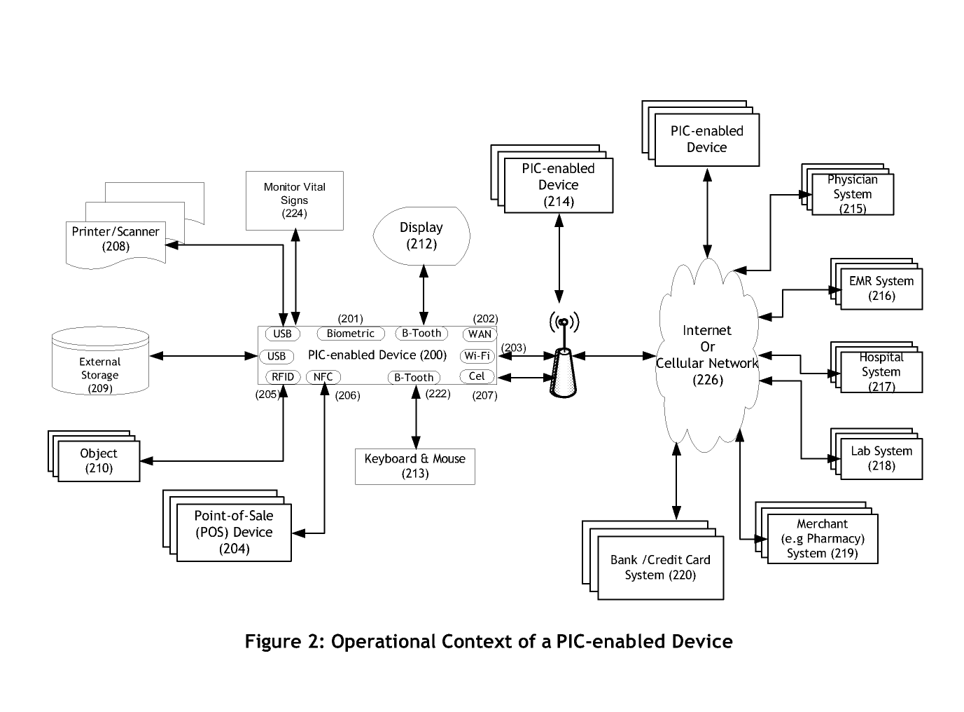

FIG. 2 is an exemplary illustration of an operational context of a PIC enabled device, in accordance with various embodiments of the present invention. Referring to FIG. 2, an electronic device 200 is illustrated with memory, CPU, display, keyboard, biometric device 201, and several means of communication such as hardwired network 202, cellular 207, Wi-Fi 203, Bluetooth 222, RFID 205, and NFC 206. The objective of this device would be to collect, organize, and make available data pertaining to distinctly different activities of a person. An example of such activity would be steps associated with healthcare providers such as hospital, physicians, laboratories and pharmacies.

Locally, the PIC-enabled device illustrated in FIG. 2 can connect to external devices such as printers 208, scanners, external storage drives 209, objects 210 (e.g. RFID tagged objects), point of sale (POS) devices 204, as well as have hardware for displaying 212 and entering information such as a display screen, keyboard 213, mouse, health monitoring devices 224, etc. In various embodiments, the PIC device can connect via a network 226 (e.g. internet, intranets 202, cellular communication networks 207, etc.) to other PIC enabled devices 214 or other systems, such as physician systems 215, emergency medical response (EMR) systems 216, hospital systems 217, laboratory systems 218, merchant and pharmacy systems 219, bank and credit card systems 220 and others.

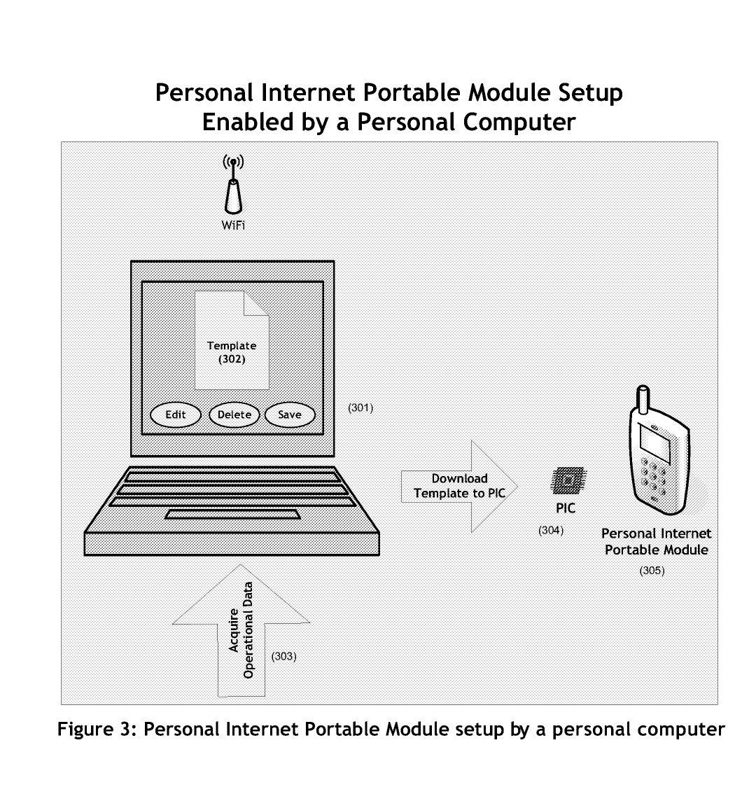

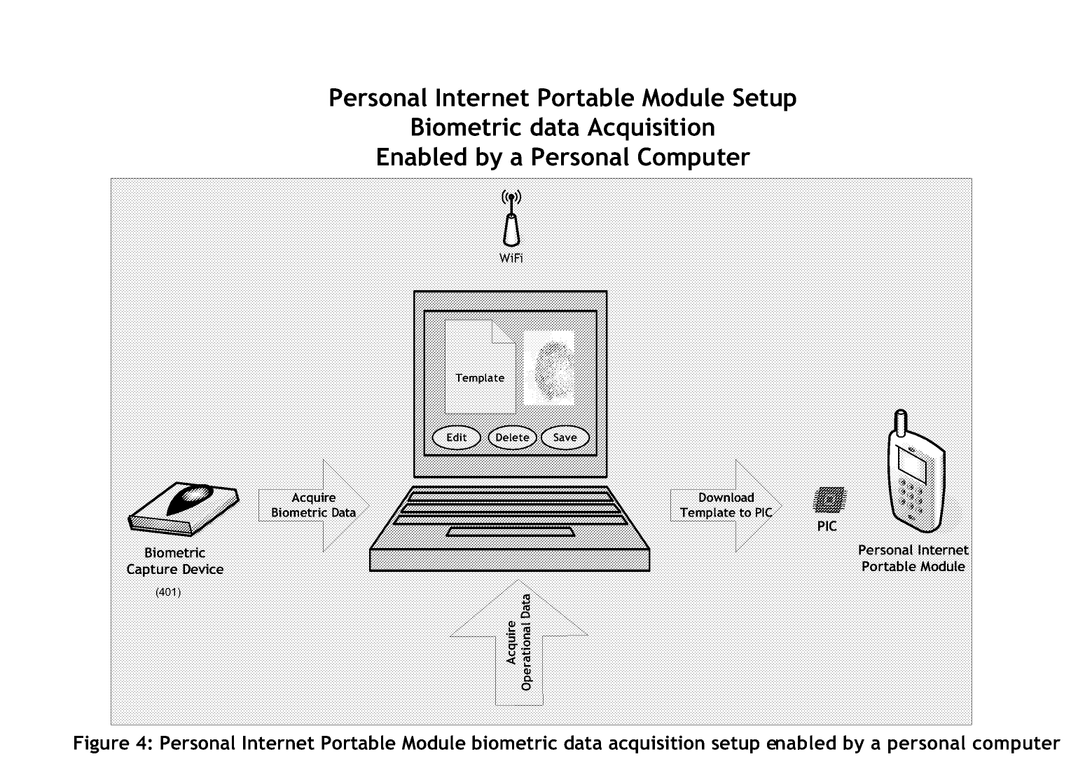

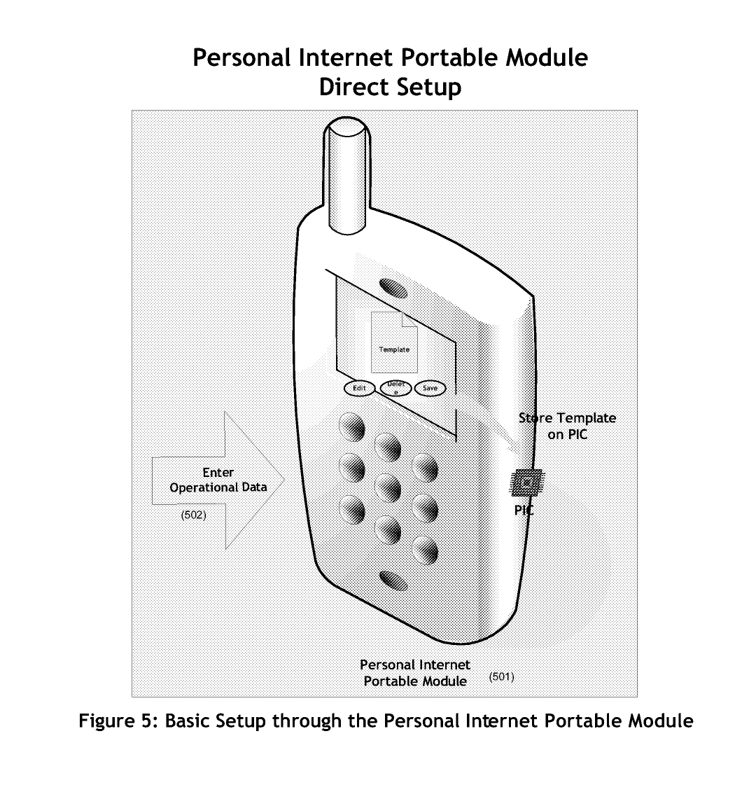

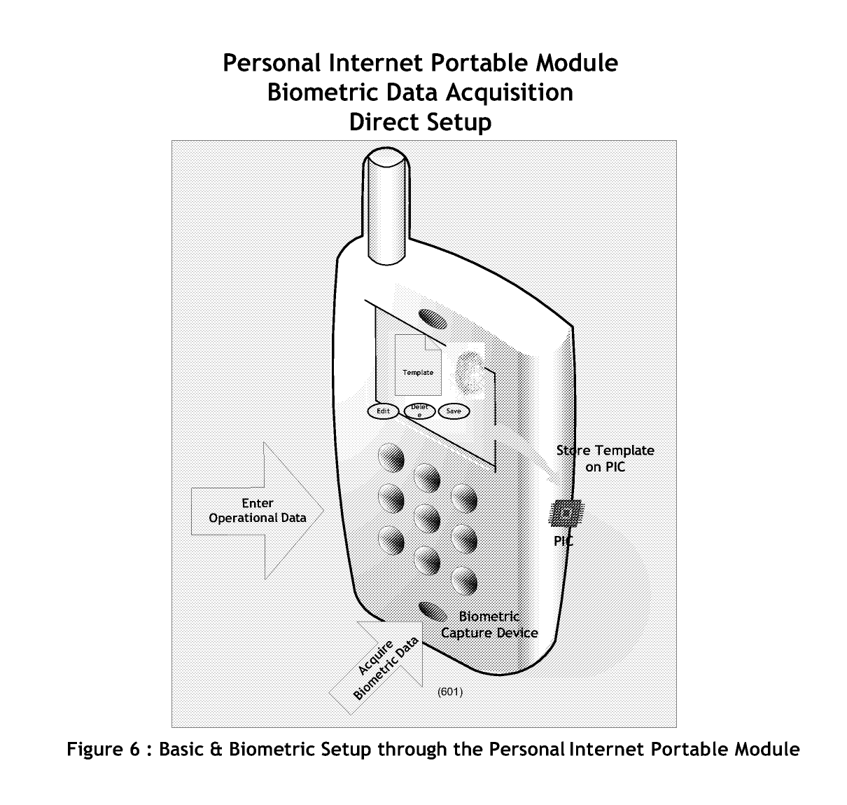

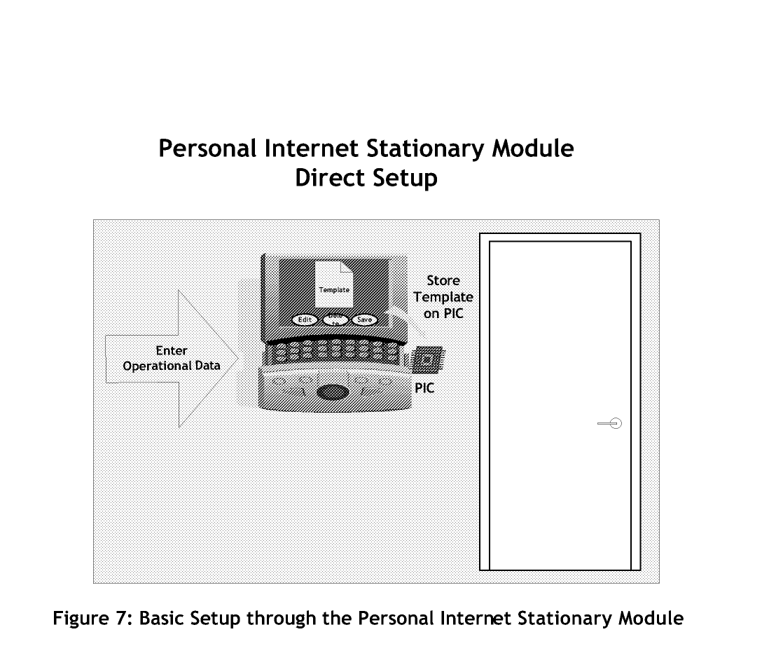

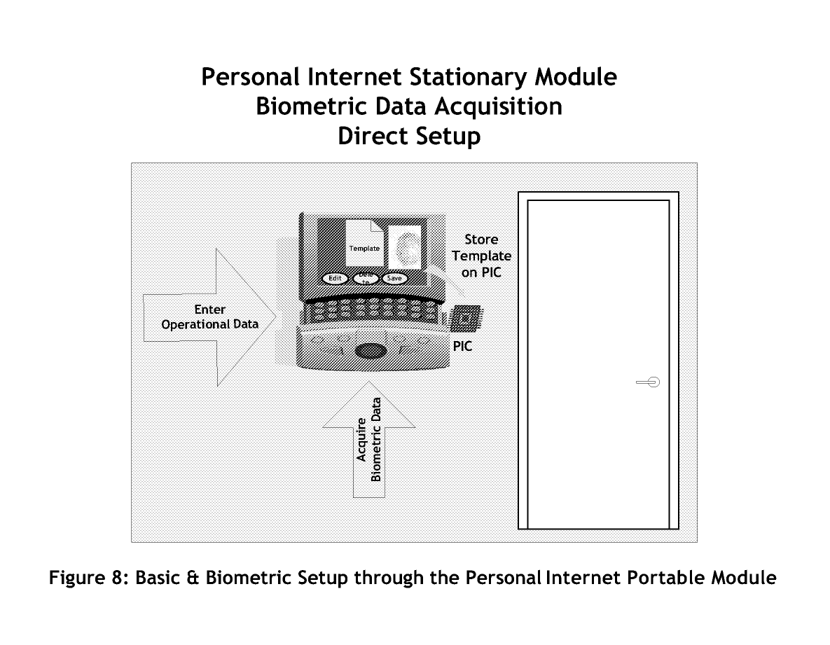

FIGS. 3-8 illustrate the various configurations and setups of the personal internet card, either directly or via external devices such as a computer. For example, FIG. 3 illustrates a laptop computer 301 that stores pre-configured templates 302 on the hard disk. The laptop can acquire operational data 303 (e.g. from a user) and input various information into templates. The data in templates can be downloaded to the PIC 304 which can be embedded into a host device such as the personal internet portable module 305. FIG. 4 illustrates a biometric capture device 401 that can enable the computer to acquire biometric data of the user. The biometric data can include fingerprints, hand geometry, retina pattern, voice pattern, DNA sample, or other types of measures of the biological or physical characteristics of the user. FIG. 5 illustrates the ability of the personal internet portable module 501 to acquire operational data directly 502, without the intermediary use of another device. Similarly, FIG. 6 illustrates the ability of the portable module to acquire biometric data directly 601, as discussed above. FIGS. 7 and 8 illustrate a personal internet stationary device such as can be deployed in a home environment. A role assigned to the PIC can determine whether the particular PIC enabled device is mobile, stationary, how it should acquire data, and various other functions.

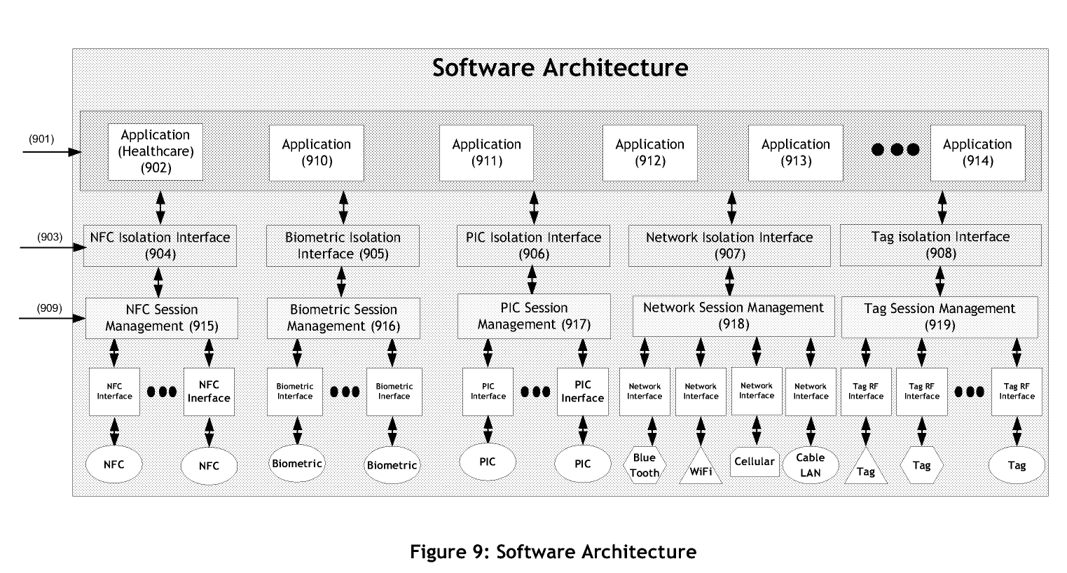

FIG. 9 illustrates an exemplary software architecture of the PIC. As shown, a number of applications can be deployed in the application layer 901 of the overall architecture. Each of these applications can manage and support functions for data associated with a specific sector. For example, a healthcare application 902 can manipulate and manage data and templates associated with hospitals, pharmacies, physicians, and so on. Each application (902, 910-914) may need to communicate with storage systems and external software systems (e.g. medical records system) via specific protocols and technologies (e.g. Wifi, cellular, wireless, etc.) The application layer can be further isolated via an isolation layer 903 that provides the standard mechanism that represents the external world and allows communication in these different protocols and technologies. For example, the near field communication (NFC) isolation interface 904 isolates the application layer from having to implement the details of NFC. Similarly, the other isolation interfaces such as the biometric isolation interface 905, PIC isolation interface 906, the network isolation interface 907 and the tag isolation interface 908 can shield the application from having to explicitly code the bytes of different corresponding protocols. In managing the various information, an application typically needs to establish a session with the external device. The session management layer 909 (e.g. NFC session management 915, Biometric session management 916, PIC session management 917, Network session management 918, Tag session management 919, etc.) can provide the session initiation, exchange of data during the session and session termination with a particular external system. In doing so, the communication can be conducted via the various interfaces to the different external devices and systems.

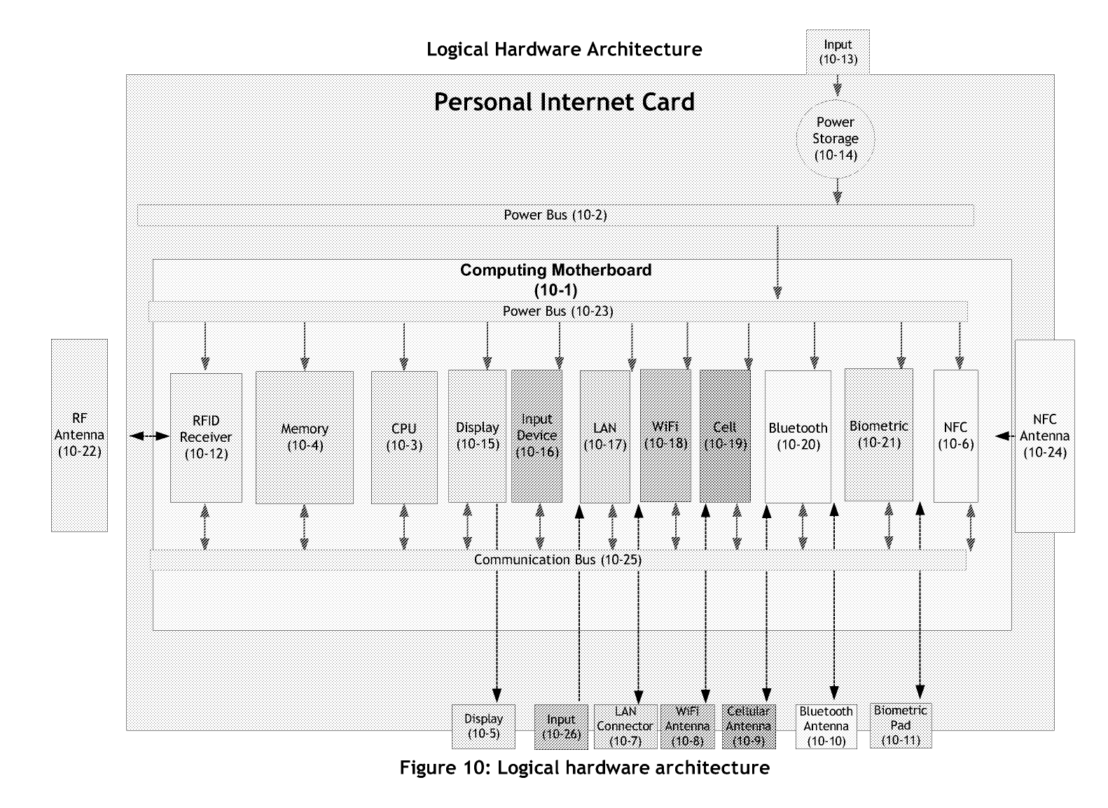

FIG. 10 is an exemplary illustration of the personal internet card logical hardware architecture, in accordance with various embodiments. It should be noted that this illustration is not intended to limit the hardware structure of the PIC and that various other components can be added and removed to the PIC within the scope of the present disclosure. As illustrated, the PIC includes a computing motherboard 10-1, power buses (10-2, 10-23) CPU 10-3, memory storage 10-4, display 10-15 communication bus 10-25, input 10-13, power storage 10-14 and components (10-6, 10-12, 10-17, 10-18, 10-19, 10-20, 10-21) for maintaining connection to different devices previously described such as the NFC antenna 10-24 LAN 10-7, Wifi 10-8, Cellular antenna(s) 10-9, Bluetooth antenna(s) 10-10, Biometric 10-11 and RFID antenna(s) 10-22. The PIC can also include a user input device 10-16 in order to receive input 10-26 from a user (e.g. a patient). The PIC can also connect to an external display component 10-5 in order to display various information to the user. Via such hardware components, the PIC can establish communication and retrieve and manipulate data from external systems such as the medical records system.

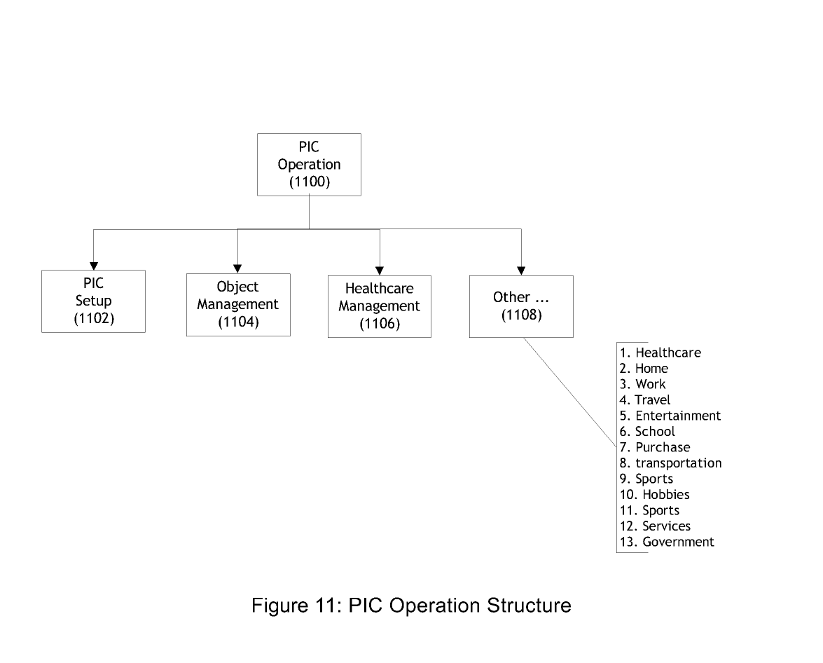

FIG. 11 is an exemplary illustration of the PIC Operation Structure 1100, in accordance with various embodiments. As an example, the operations of the internet card can include setting up the PIC with the configuration data 1102, managing and keeping track of objects 1104 and their associated data, healthcare information management 1106, and various other operations 1108.

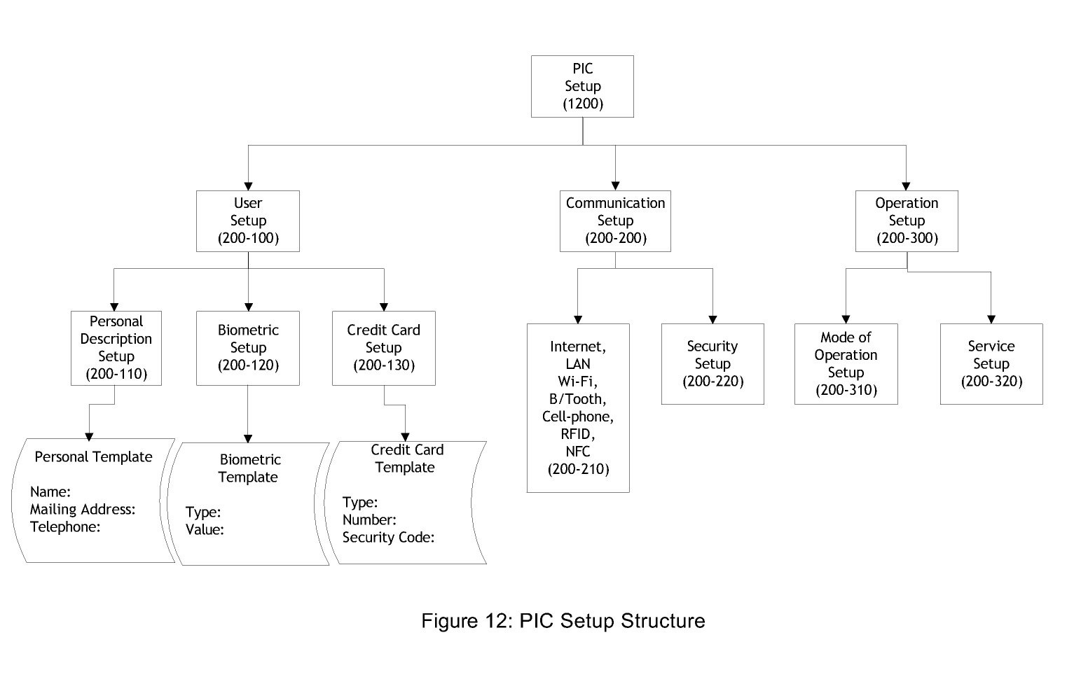

FIG. 12 is an exemplary illustration of the setup 1200 of the personal internet card, in accordance with various embodiments. In one embodiment, the setup of the PIC can be separated into specific configuration of user data 200-100, communication setup 200-200 and operation setup 200-300. For example, the user-specific setup data can include templates for storing personal description 200-110 of the user(s), biometric setup 200-120, credit card information 200-130 and various other data. The communication setup data can include the necessary information for enabling wireless, LAN, Wifi, internet, cellular, RFID and NFC communications 200-210. Similarly, the communication setup can also include the necessary authentication/authorization data 200-220 needed to gain access to various external systems. The operation setup 200-300 can specify the mode of operation 200-310, setup of various services 200-320, and so forth.

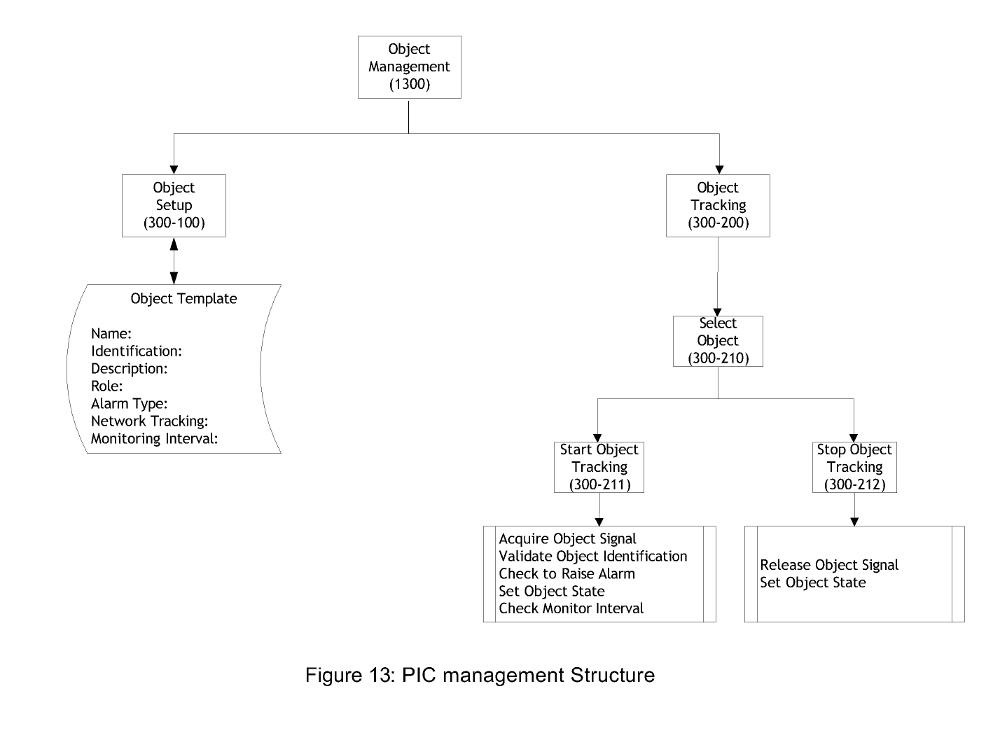

FIG. 13 is an exemplary illustration of the object management 1300 feature of the PIC, in accordance with various embodiments. As illustrated, object management can include object set up 300-100 and subsequent object tracking 300-200 performed by the PIC. In one embodiment, object tracking involves obtaining information and user-preferences about the object being tracked 300-210, such as the name, ID, description, role, monitoring interval, alarm type, network tracking and various other information associated with each particular object. Object tracking then be started 300-211 which involves acquiring an object signal such as via RFID technology, monitoring the object, validating its identification, maintaining its state information and issuing alerts when a distance between the object exceeds a pre-determined threshold value. In one embodiment, object tracking can also be stopped 200-212, such as by releasing the object signal and setting the appropriate object state.

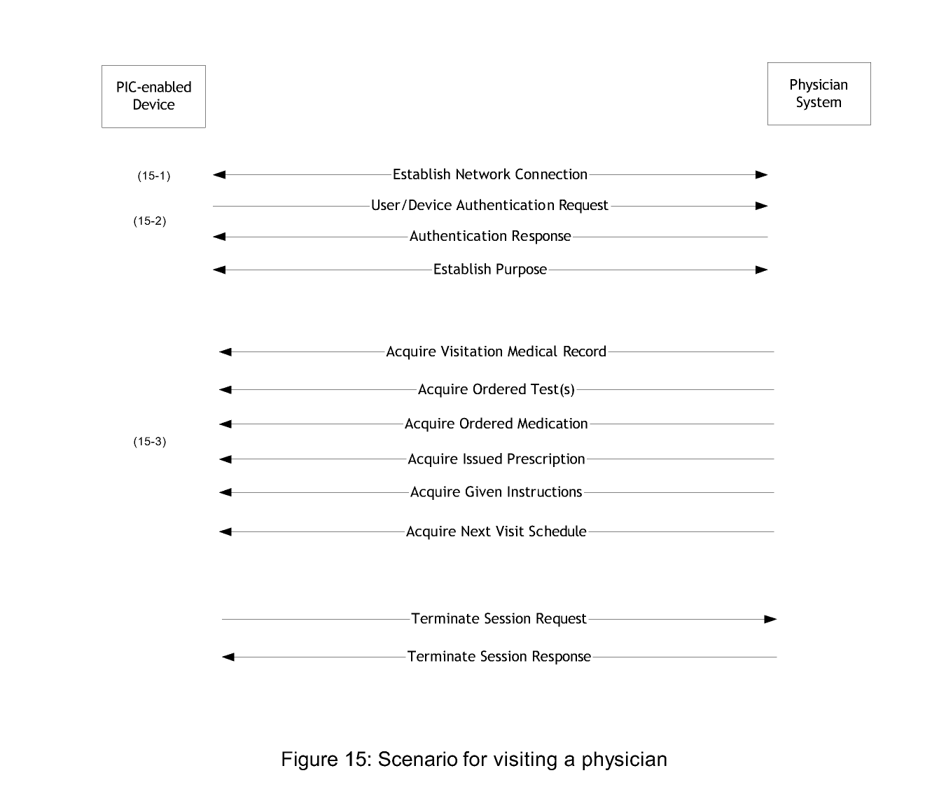

FIG. 15 is an exemplary illustration of a sample scenario for visiting a physician by a PIC user. Referring to FIG. 15, it is envisioned that this device would be carried by a user in order to assist the user with the steps they need to take for a specific activity. For example, a user can take this device when they visit a physician. As they walk into the physician's office this device would establish communication with the physician system, identifying itself and getting authenticated as an electronic device that belongs to a known patient. To achieve this authentication this device may utilize a typical username and password mechanism or a biometric data belonging to the user. During the visit, as the physician enters data into their system, a copy of this data can also be sent to the PIC-enabled device. For example, the day and time of visit, the physician's name, physician notes, ordered laboratory tests, medication prescribed, medication ordered directly with a pharmacy, procedures to be followed, and recommended follow-up, would be transmitted to the PICenabled device by the physician or hospital system. This type of background data collection takes patient-specific data out of a difficult-to-reach physician or hospital system and places it in the hands of the patient.

In various embodiments, the users can take their PIC-enabled device with them when they visit a lab for an X-ray, MRI, CT-Scan, or blood work. In a similar manner, as when the PIC-enabled device behaved at the physician's office, it could establish communication 15-1 with the lab system and go through an authentication process 15-2. It can then collect data about the facility, dates and times of the tests performed 15-3, the type of tests performed, and even collect test results as and when they become available.

By collecting patient-specific data, the PIC-enabled device could then make the data available to other people such as physicians and at times of emergency to medical response team or hospital staff. Physicians could review the data directly on the display of the PIC-enabled device. Alternatively, the data could be downloaded to the physician or hospital system and added to the patient's file.

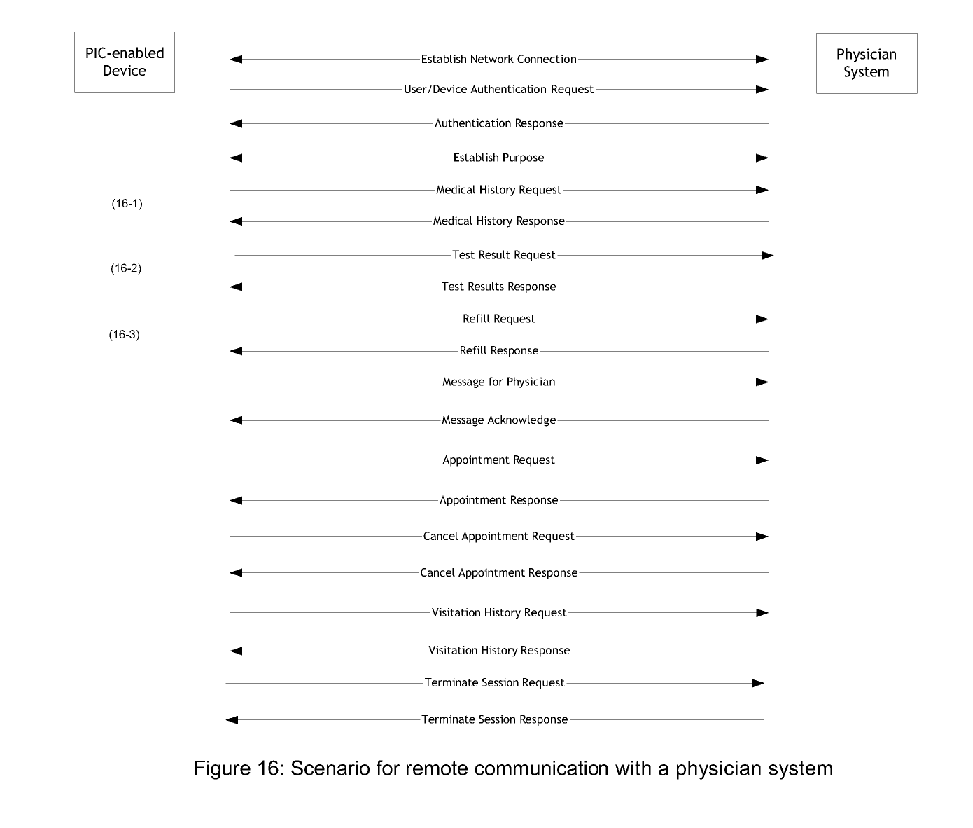

FIG. 16 is an exemplary illustration for remote communication between the PIC and the physician system, in accordance with various embodiments. Referring to FIG. 16, this device can assist people by providing the capability to request a copy of their medical records 16-1 and tests performed 16-2 at labs from their physicians and labs visited. This request could be made by the PIC-enabled device when it has access to the Internet, or when it can dial-in to other systems utilizing a modem.

The PIC device would keep track of ordered medication 16-3, order status, as well as request refills from a pharmacy and pay for them without having to call the pharmacy or travel to it.

This device could also keep track of items that the user considers important. For example, it could remind the user that they are about to leave the house without their medication, wallet, car keys, or cellular telephone.

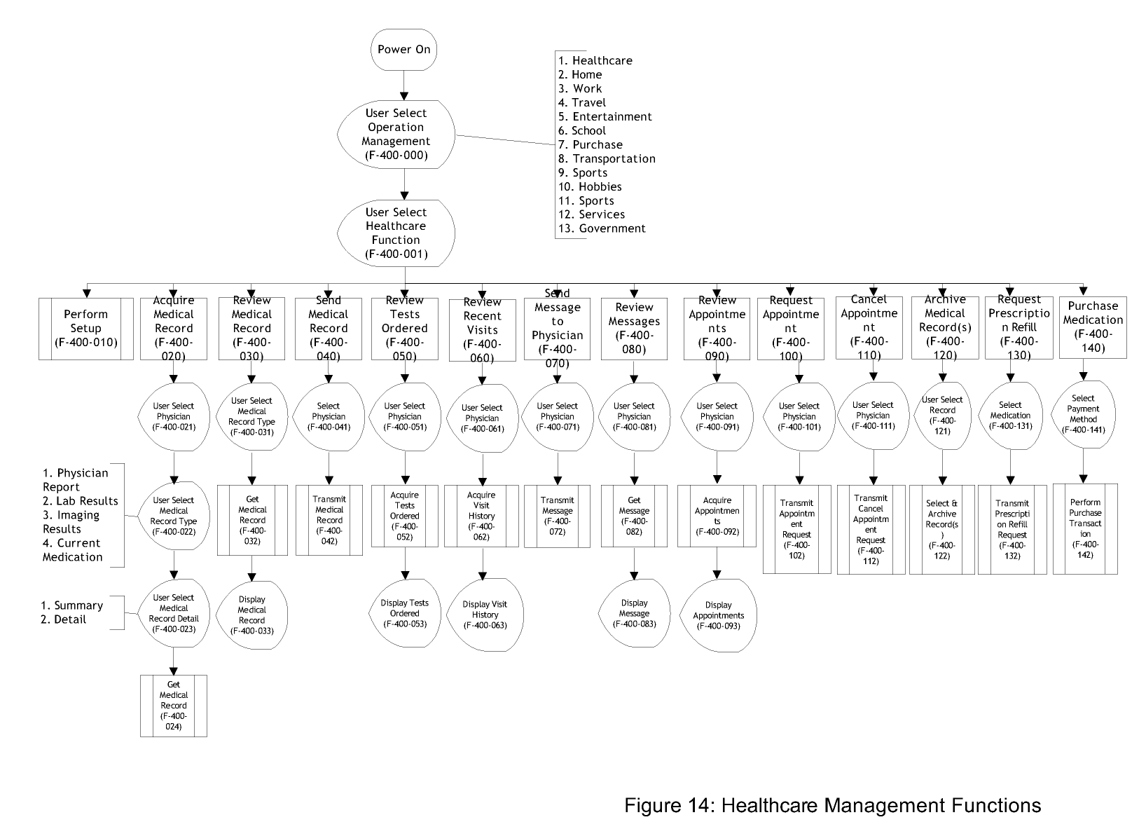

FIG. 14 is an exemplary illustration of the various healthcare management functions, in accordance with various embodiments. As illustrated, the various embodiments enable user select operation management (F-400-000) and user select healthcare functions (F-400-001). Referring to FIG. 14, embodiments of the present invention provide systems and methods for the following functions:

(F-400-010) Perform Healthcare function Setup, including but not limited to the following:
Physician information such as name, address, telephone number, service level, data acquisition type, data transmission type, and means of communication such as network address and VPN configuration.
Pharmacy name, address, telephone number, and means of communication such as network address and VPN configuration.
Setup procedures, conditions and actions

(F-400-020) Acquire Medical Record provides the capability for a user to select either a summary of detailed records of physician reports, lab results, imaging results and reports, and current medication (F-400-021), (F-400-022), (F-400-023).

(F-400-024) Get Medical Record provides the capability to obtain medical records by any means available such as but not limited to a network and a scanner. In a typical situation this function would establish communication with a physician or hospital medical records system and request a copy of the patient's records. This communication could take place over the Internet utilizing a secure VPN. The Internet connection could be established through although not limited to a WiFi, hardwired, or cellular telephone.

(F-400-030) Review Medical Record provides the capability to select a record and display on the PIC-enabled device (F-400-031), (F-400-033). In one embodiment, the Get Medical Record function (F-400-032) reads previously stored medical records from PIC storage.

(F-400-040) Send Medical Record provides the capability to send or reproduce stored medical records to another computer such but not limited to as a physician's system or a printer. The physician can be selected (F-400-041) and the Transmit Medical Record function (F-400-042) provides the capability to transmit selected medical records through communication mechanisms to devices such as a printer spooler or a handshaking protocol to a network application.

(F-400-050) Review Test Ordered provides the capability to obtain tests that have been ordered by a physician but not performed and the date they should be performed by. The user can select a physician (F-400-051) and the Acquire Tests Ordered function (F-400-052) provides the capability to communicate with a physician computer system and request a list of tests ordered for the patient. This communication could take place over the Internet utilizing a secure VPN. The Internet connection could be established through although not limited to a Wi-Fi, hardwired, or cellular telephone. Alternatively, a user may choose to enter this information into their PIC-enabled device; in which case the information would be retrieved from the PIC storage and formatted to be displayed on the PIC display. In various embodiments, a variety of medical tests can be ordered (F-400-053).

(F-400-060) Review Recent Visits provides the capability to obtain from the physician or hospital systems a list of recent visits to the physician, along with dates, times, and the reason for the visit. Alternatively, this information could be obtained from the PIC storage and formatted to be displayed to the user. A PIC-enabled device could have accumulated this data because the user had entered it at some point in time. Alternatively, a PIC-enabled device could have collected this data during the patient's visit to the physician or hospital by establishing a communication link with their systems and requested the latest history. The user can select a physician (F-400-061) and the Acquire Visit History function (F-400-062) provides the capability to either establish communication with a physician or hospital systems, or to obtain the required data from PIC storage, based on the request received from Review Recent Visits function. The history of the visits can be displayed (F-400-063).

(F-400-070) Send Message to Physician provides the capability for the user to create a message and send it to a specific physician. A copy of the message, including when it was sent and who it was sent to will be saved in the PIC storage for future review. The user can select a physician (F-400-071) and the Transmit Message function (F-400-072) provides the capability to establish communication with a physician or hospital system and send an electronic message.

(F-400-080) Review Messages provides the capability to review send and received messages. These messages would have been stored on the PIC storage during previously completed transactions. The user can select a physician (F-400-081) and the Get Message function (F-400-082) provides the capability to read a message from the PIC storage. The messages can then be displayed (F-400-083).

(F-400-090) Review Appointments provides the capability to get a list of appointments and display them to the user. Appointments may have been stored on the PIC storage or they may have to be obtained from the physician or hospital system. The user can select a physician (F-400-091) and the Acquire Appointment function (F-400-092) provides the capability to either read appointments stored on the PIC storage, or to establish communication with the physician or hospital system and request a list of up-coming appointments. The appointments can then be displayed (F-400-093).

(F-400-100) Request Appointment provides the capability to send an appointment request to a physician or hospital. The user would specify the type of appointment such as the physician and the reason for the request by creating a message. The user can select a physician (F-400-101) and the Transmit Appointment Request function (F-400-102) provides the capability to format and send an appointment request to a physician or hospital system.

(F-400-110) Cancel Appointment provides the capability to make a request from the physician or hospital system to cancel an existing appointment. The user can select a physician (F-400-111) and the Transmit Cancel Appointment Request function (F-400-112) provides the capability to format and send a cancel appointment request to a physician or hospital system.

(F-400-120) Archive Medical Records provides the capability to copy medical records that are older than a certain date to an external device. To achieve this function, the user would connect the PIC-enabled device to an external storage such as memory card or hard drive. The user can select a record (F-400-121) and the Select and Archive Records function (F-400-122) provides the capability to select and copy records that fit the user-specified criteria to an external storage device.

(F-400-130) Request Prescription Refill provides the capability for the user to select the medication and communicate the refill request to a pharmacy system. The user can select a medication (F-400-131) and the Transmit Prescription Refill Request function (F-400-132) provides the capability to establish communication with a specific pharmacy system and transmit the refill request.

(F-400-140) Purchase Medication provides the capability to purchase medication from a pharmacy. This function would request from the pharmacy system a list of medications that are ready for pickup, along with the cost. This cost would have taken into account insurance payment. The user would then select a credit or debit card as the means to pay for their medication. The user can select a payment method (F-400-141) and the Perform Purchase Transaction function (F-400-142) provides the capability to make payment for selected medication using a specified credit or debit card.

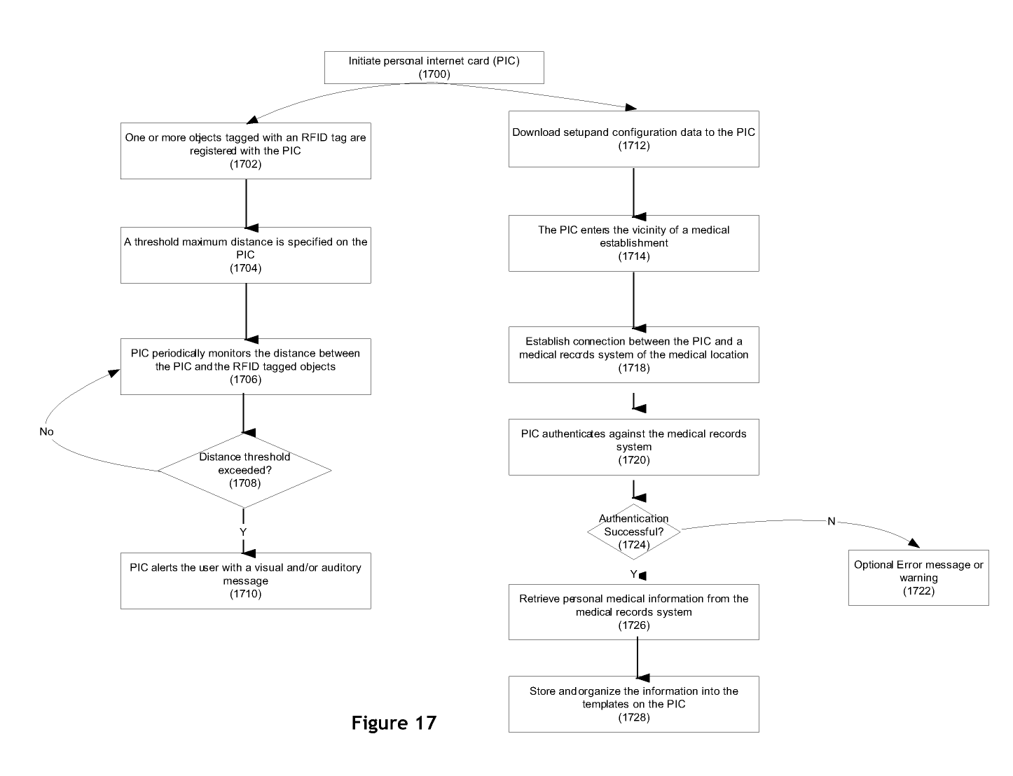

FIG. 17 is an exemplary logical flow diagram of processes in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged or adapted in various ways. It should also be noted that the various processes illustrated in this figure can be performed synchronously or asynchronously and can also be executed via different threads simultaneously in parallel, or sequentially.

As illustrated, in step 1700, the personal internet card can be initiated, such as by powering on an electronic device that hosts the PIC. Setup configuration data can be downloaded to the device 1712 and one or more objects can be registered to be tracked by the PIC 1702. The object can be any object that has a radio frequency identification (RFID) tag attached thereto. In one embodiment, the object is a medical object such as a medication container or a piece of medical equipment. The setup information can be any configuration-type data used to configure the personal internet card upon startup. As some non-limiting examples, the configuration data could specify user preferences, the role of the PIC in a network, personal contacts, call forwarding numbers (in the case of cellular phones), a distance threshold for tracking objects, as well as various other types of configuration information.

In step 1704, the maximum threshold distance is specified and stored on the PIC. The threshold can be a value specified by a user as one of the preferences entered upon startup. Alternatively, a default value can be used. In one embodiment, the PIC periodically monitors the physical distance between itself and an object(s) tagged with RFID 1706. If at any point, the distance threshold is exceeded 1708 (such as when a tracked object leaves the area monitored by the PIC), the PIC can alert the user, such as via audible sound and/or visual alert message 1710.

A standard radio frequency (RF) transmitter and a receiver can be used to enable the object tracking functionality. In one embodiment, the PIC can function as the receiver and the RFID tag placed on the object can function as the transmitter. The transmitter can be manufactured and provided to the user along with the PIC so as to enable the user to tag his/her personal objects such as medication, keys, electronic equipment, etc. In alternative embodiments, the normal RFID tags placed on medication containers and other objects can be used and the user is not required to actually tag the object. Various other embodiments are also possible, such as the PIC functioning as the transmitter or any other RFID technology implementation, as can be derived from the present specification.

In one scenario, the personal internet card (or a PIC-enabled device) can enter the vicinity of a medical establishment 1714 such as a hospital, physician's office or laboratory for performing tests. At this point a connection (e.g. wireless) can be established 1718 between the PIC and a medical records system of the particular location. For example, hospitals typically have computer systems for maintaining records regarding patients and their medical histories. In one embodiment, the PIC can connect to such a records system and authenticate itself 1720, such as by providing a user name and password, security token, or any other security mechanism. If the authentication is not successful 1724, a warning message, error or an exception can be thrown, whereby the PIC can be prevented access to the medical system (step 1722). If the authentication results in success, the PIC can then electronically communicate with the records system 1726 in order to perform various functionality, as previously described throughout the present disclosure, such as retrieving medical histories, acquire ordered tests, acquire prescriptions and refills, schedule next doctor visit, or retrieve and manipulate various other types of information. In some embodiments, that information is stored and organized into templates in the storage medium of the PIC 1728.

As one illustration, the x-rays, MRIs, medical charts and various other documents can be scanned into the medical records system within a hospital. In one embodiment, the PIC can obtain copies of such materials electronically (such as via a Wifi connection), store this information into a template pre-configured specifically to contain this type of medical information, and update that information any time it is changed within the system. In this manner, the medical information paper trail can be electronically managed by the PIC automatically performing various functions for the user, such as maintaining a fully updated medical record across different hospitals and physicians, automatically refilling prescriptions, notifying the user that may lose track of objects and scheduling or canceling appointments. Accordingly, useful information can be maintained, extracted, duplicated, personalized and otherwise utilized by patients or other users of the product.

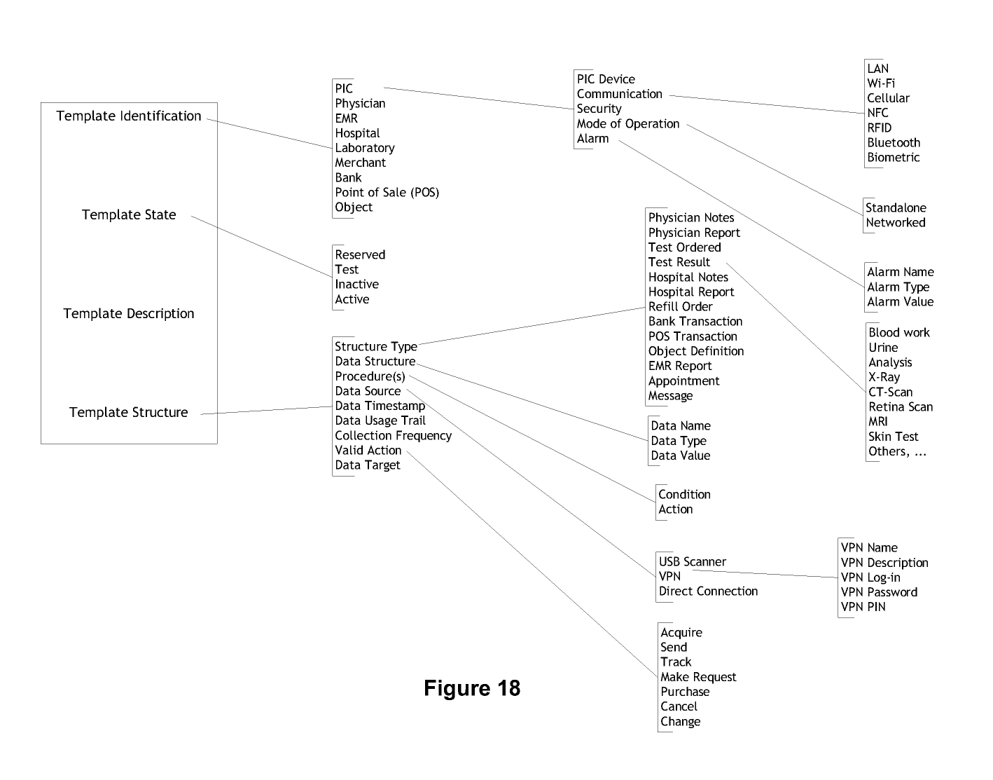

FIG. 18 is an illustration of an exemplary set of templates for storing data onto the personal internet card, in accordance with various embodiments. As illustrated, templates can be structured in a hierarchical manner, where each field of a template can have another template associated therewith in order to store and organize its information. For example, the template can contain a template identification field, a template state field, a template description field and a template structure field. Each of these fields can further be associated with other templates. As shown, the identification field can identify the particular template that will store data, by identifying the PIC, physician, EMR, hospital, laboratory, merchant, bank, point of sale (POS) or object that the template stores data for. The PIC field can be associated with the template that stores specific information about the PIC device, such as communication (Wifi, NFC, Bluetooth, etc.), security modes, alarm and other information. The template state field can maintain state information about the PIC, such as whether the device is reserved, test, inactive or active. Similarly, other fields of the card can maintain appropriate medical or financial information, technical data required for making various connections, as well as other user specific data. The use of templates can enable the organization of information on an application-specific basis, as each template can be pre-configured and tailored to host a specific kind of information.

The various embodiments include the software and hardware as well as the general business process previously described. For example, various embodiments of the invention described above include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for electronically managing a medical paper trail of a user, said method comprising:
entering a vicinity of a medical location by a personal internet card (PIC);
establishing a connection between said personal internet card (PIC) and a medical records system in said medical location;
authenticating said PIC as being associated with said user to the medical records system; and
retrieving a set of medical information associated with said user from the medical records system and storing the retrieved medical information in one or more templates on the PIC.

2. The method of claim 1, further comprising:
monitoring a distance between said personal internet card and one or more objects wherein each object is tagged with a radio frequency identifier (RFID) tag;
detecting that said distance between the personal internet card and the one or more objects has exceeded a predefined threshold value; and
alerting said user upon exceeding said threshold value.

3. The method of claim 2 wherein said object is a medical object that includes at least one of: a medication container tagged with an RFID tag, a medical equipment device and a prescription.

4. The method of claim 1, further comprising:
establishing a connection between said PIC and a health monitoring device, said health monitoring device including at least one of: a blood pressure monitor, a blood sugar monitor, a vital signs monitor, a heart rate monitor, a pulse monitor, an electrocardiogram monitor, a respiration monitor and a temperature monitor; and
retrieving, by said PIC, health information of said user from the health monitoring device.

5. The method of claim 4, further comprising:
periodically transmitting the health information by said PIC to an external system.

6. The method of claim 5 wherein periodically transmitting the health information further includes:
establishing an internet connection by the PIC;
generating an electronic mail message by said PIC, said electronic mail message containing said health information; and
transmitting the electronic mail message to an electronic mail address at said external system.

7. The method of claim 1 wherein said personal internet card further includes:
a storage medium for storing said medical information associated with the user in said templates;
a central processing unit (CPU) that manipulates the medical information stored in said templates and retrieves the medical information from the medical records system; and
a wireless communication component that provides said connection between the personal internet card and the medical records system.

8. The method of claim 1 wherein said personal internet card is embedded into an electronic device, said electronic device including at least one of:
a personal digital assistant (PDA), a cellular telephone, a computer, a personal internet portable module and a personal internet stationary module.

9. An apparatus for electronically managing a medical paper trail of a user, said apparatus comprising:
a storage medium for storing medical information associated with said user, said medical information including at least one of: patient-specific laboratory data, patient-specific medication prescription data, physician notes, patient-specific medical procedures, patient-specific test results, patient-specific X-ray data, patient-specific MRI data and patient-specific CT-Scan data;
a wireless communications component that enables said CPU of the apparatus to connect to one or more networks and communicate with at least one other electronic device; and
a central processing unit (CPU) that establishes a connection between said apparatus and a medical records system, identifies said apparatus as being associated with said user, retrieves said medical information associated with the user and organizes and stores the medical information into one or more templates on said storage medium.

10. A system for providing a personal internet of objects and information, said system comprising:
a personal internet card (PIC) that includes a catalogue of templates configured with data tailored toward a specific usage, each template having a template-type designed for a specific application;
one or more objects associated with radio frequency identification (RFID) tags, wherein data associated with said one or more objects is stored in said catalog of templates of the personal internet card; and
a setup module that collects said data associated with the one or more objects and organizes said data into partially pre-populated templates, wherein the setup module resides on said personal internet card.

11. The system of claim 10, wherein one or more objects include at least one of: a medication container tagged with an RFID tag, a medical equipment device and a prescription.

12. The system of claim 10 wherein said catalog of templates further contains information scanned from one or more medical documents that include at least one of:
laboratory data, medication prescription data, physician notes, medical procedures, test results, X-ray data, MRI data and CT-Scan data.

13. The system of claim 10 wherein the personal internet card monitors a distance between said personal internet card and said one or more objects such that the personal internet card issues an alert message upon said distance exceeding a threshold value.

14. The system of claim 10, further comprising:
an electronic health monitoring device that obtains health information of a user, wherein a connection is established between said electronic health monitoring device and the personal internet card and said health information is downloaded to the personal internet card.

15. The system of claim 14 wherein said electronic health monitoring device includes at least one of:
a blood pressure monitor, a blood sugar monitor, a vital signs monitor, a heart rate monitor, a pulse monitor, an electrocardiogram monitor, a respiration monitor and a temperature monitor.

16. The system of claim 10 wherein said personal internet card is further adapted to download and upload data to and from a personal computer via a universal serial bus (USB) interface.

17. The system of claim 10, further comprising:
a network of interconnected plurality of said personal internet cards, wherein each personal internet card is assigned a role in the network, said role specifying the function

18. The system of claim 10 wherein the PIC contains information associated with a user and one or more objects, said information including:
setup configuration data for said personal internet card;
templates pre-configured for a specific application, said application configured to manipulate data stored in said templates; and
a set of functional rules that specify at least one of: how said data stored in the templates is to be used and a set of services that are offered to said user.
